(19) United States
(12) Patent Application Publication
(10) Pub. No.: US 2024/0332728 A1
(43) Pub. Date: Oct. 3, 2024

(54) BATTERY FIRE SUPPRESSION SYSTEM AND METHOD

(71) Applicants: High Desert Racing Products, LLC, Reno, NV (US); Hypercraft Inc., Provo, UT (US)

(72) Inventors: Ryan Kalb, Provo, UT (US); Jacob Hawksworth, Provo, UT (US)

(21) Appl. No.: 18/625,578

(22) Filed: Apr. 3, 2024

Related U.S. Application Data
(60) Provisional application No. 63/456,757, filed on Apr. 3, 2023.

(51) Int. Cl. H01M 50/383; A62C 3/16; A62C 37/36; H01M 10/48

(52) U.S. Cl. CPC H01M 50/383; A62C 3/16; A62C 37/04; A62C 37/36; H01M 10/486; H01M 2200/10; H01M 2200/20; H01M 2220/20

(57) ABSTRACT

A battery fire suppression system comprising one or more battery packs; one or more sensors disposed internal to the one or more battery packs; a fire suppressant deployment system; a controller, one or more software modules that, when executed by the controller, receive one or more signals from the one or more sensors indicative of one or more conditions internal to the one or more battery packs; actuate the fire suppressant deployment system to deploy a fire suppressant to suppress a fire or possible fire in the one or more battery packs if the one or more signals are indicative of a thermal runaway in the one or more battery packs.

### CROSS-REFERENCE TO RELATED APPLICATION

This application claims the benefit of U.S. Provisional Patent Application No. 63/456,757, filed Apr. 3, 2023, under 35 U.S.C. 119 and is incorporated herein in its entirety.

### FIELD OF THE INVENTION

The present invention relates to lithium ion battery fire suppression systems and methods.

### BACKGROUND OF THE INVENTION

Fire suppression systems of the past are not designed to properly address the complexities of a lithium battery fire. Even if the fire suppression system is capable of being integrated into the internals of the battery pack, it is not effective in preventing larger battery fires because the battery fire is often detected too late. The battery cells reach a temperature before proper detection that makes it almost impossible to extinguish.

### SUMMARY OF THE INVENTION

An aspect of the present disclosure involves an intelligent, autonomous, battery fire suppression system comprising one or more sensors that provide real time data from inside a battery pack system; a logic controller with programmed logic to analyze the sensor data and detect a thermal runaway; and an electronically controlled deployment system to release a fire suppressant to suppress the battery fire.

Another aspect of the present disclosure involves a battery fire suppression system comprising one or more battery packs; one or more sensors disposed internal to the one or more battery packs; a fire suppressant deployment system; a controller, one or more software modules that, when executed by the controller, receive one or more signals from the one or more sensors indicative of one or more conditions internal to the one or more battery packs; actuate the fire suppressant deployment system to deploy a fire suppressant to suppress a fire or possible fire in the one or more battery packs if the one or more signals are indicative of a thermal runaway in the one or more battery packs.

One or more implementations of the aspect of the disclosure described most immediately above includes one or more of the following: the one or more battery packs are one or more lithium-ion battery packs; a vehicle including the one or more battery packs; the one or more sensors include one or more of the following sensors: temperature sensor, pressure sensor, chemical sensor, vibration sensor, shock sensor, electrical sensor, current sensor; the one or more sensors include one or more temperature sensors, one or more pressure sensors, and one or more chemical sensors; the fire suppressant deployment system includes an electronic valve, and the one or more software modules that, when executed by the controller, control the electronic valve to deploy a fire suppressant to suppress the fire or possible fire in the one or more battery packs if the one or more signals are indicative of a thermal runaway in the one or more battery packs; the one or more sensors include one or more temperature sensors, and the one or more software modules that, when executed by the controller, actuate the fire suppressant deployment system to deploy a fire suppressant to suppress a fire or possible fire in the one or more battery packs if the one or more signals are indicative of temperature above a threshold in the one or more battery packs; the one or more sensors include one or more pressure sensors, and the one or more software modules that, when executed by the controller, actuate the fire suppressant deployment system to deploy a fire suppressant to suppress a fire or possible fire in the one or more battery packs if the one or more signals are indicative of pressure above a threshold in the one or more battery packs; and/or the one or more sensors include one or more chemical sensors, and the one or more software modules that, when executed by the controller, actuate the fire suppressant deployment system to deploy a fire suppressant to suppress a fire or possible fire in the one or more battery packs if the one or more signals are indicative of cell outgassing in the one or more battery packs.

A further aspect of the present disclosure involves a method of using a battery fire suppression system comprising providing a battery fire suppression system comprising one or more battery packs; one or more sensors disposed internal to the one or more battery packs; a fire suppressant deployment system; a controller, one or more software modules that, when executed by the controller, receive one or more signals from the one or more sensors indicative of one or more conditions internal to the one or more battery packs; actuate the fire suppressant deployment system to deploy a fire suppressant to suppress a fire or possible fire in the one or more battery packs if the one or more signals are indicative of a thermal runaway in the one or more battery packs; receiving via the controller the one or more signals from the one or more sensors indicative of one or more conditions internal to the one or more battery packs; actuating via the controller the fire suppressant deployment system to deploy the fire suppressant to suppress a fire or possible fire in the one or more battery packs if the one or more signals are indicative of a thermal runaway in the one or more battery packs.

One or more implementations of the aspect of the disclosure described most immediately above includes one or more of the following: the one or more battery packs are one or more lithium-ion battery packs; a vehicle including the one or more battery packs; the one or more sensors include one or more of the following sensors: temperature sensor, pressure sensor, chemical sensor, vibration sensor, shock sensor, electrical sensor, current sensor; the one or more sensors include one or more temperature sensors, one or more pressure sensors, and one or more chemical sensors; the fire suppressant deployment system includes an electronic valve, and controller controls the electronic valve to deploy a fire suppressant to suppress the fire or possible fire in the one or more battery packs if the one or more signals are indicative of a thermal runaway in the one or more battery packs; the one or more sensors include one or more temperature sensors, and the controller actuates the fire suppressant deployment system to deploy a fire suppressant to suppress a fire or possible fire in the one or more battery packs if the one or more signals are indicative of temperature above a threshold in the one or more battery packs; the one or more sensors include one or more pressure sensors, and the controller actuates the fire suppressant deployment system to deploy a fire suppressant to suppress a fire or possible fire in the one or more battery packs if the one or more signals are indicative of pressure above a threshold in the one or more battery packs; and/or the one or more sensors include one or more chemical sensors, and the controller actuates the fire suppressant deployment system to deploy a fire suppressant to suppress a fire or possible fire in the one or more battery packs if the one or more signals are indicative of cell outgassing in the one or more battery packs.

### BRIEF DESCRIPTION OF DRAWINGS

The accompanying drawings, which are incorporated in and form a part of this specification illustrate embodiments of the invention and together with the description, serve to explain the principles of the invention.

FIG. 1 is a block diagram of an intelligent, autonomous, battery fire suppression system.

FIG. 2 is a flow chart of an exemplary method of use of the intelligent, autonomous, battery fire suppression system of FIG. 1.

FIG. 3 is a block diagram illustrating an example wired or wireless processor enabled device that may be used in connection with various embodiments described herein.

### DESCRIPTION OF EMBODIMENT OF THE INVENTION

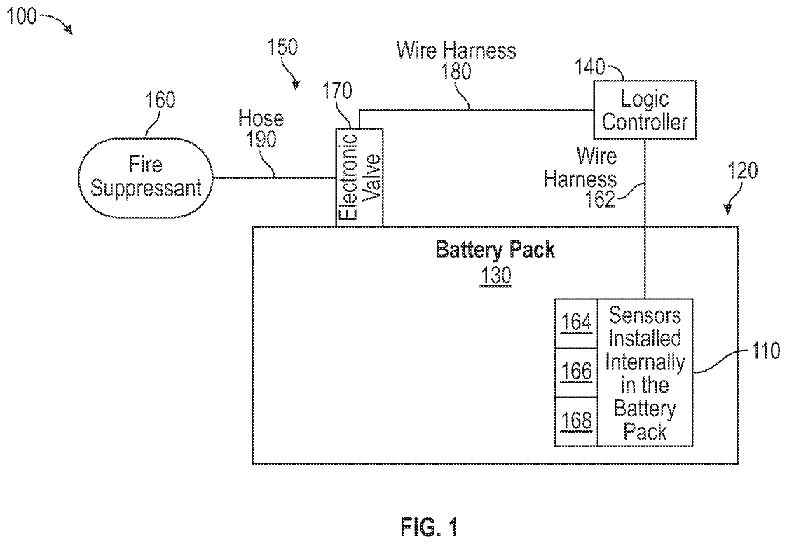

With reference to FIG. 1, an embodiment of an intelligent, autonomous, battery fire suppression system 100 comprises one or more sensors 110 that provide real time data from inside a battery pack system 120 including one or more battery packs (e.g., lithium ion battery pack(s)) 130, a controller 140 with programmed logic to analyze the sensor data and detect a thermal runaway, and an electronically controlled deployment system 150 to release a fire suppressant 160 to suppress the battery fire. In one or more embodiments, the intelligent, autonomous, battery fire suppression system 100 is a system within a vehicle including, but not limited to, auto, truck, bus, train, trolley, off-road vehicle, boat.

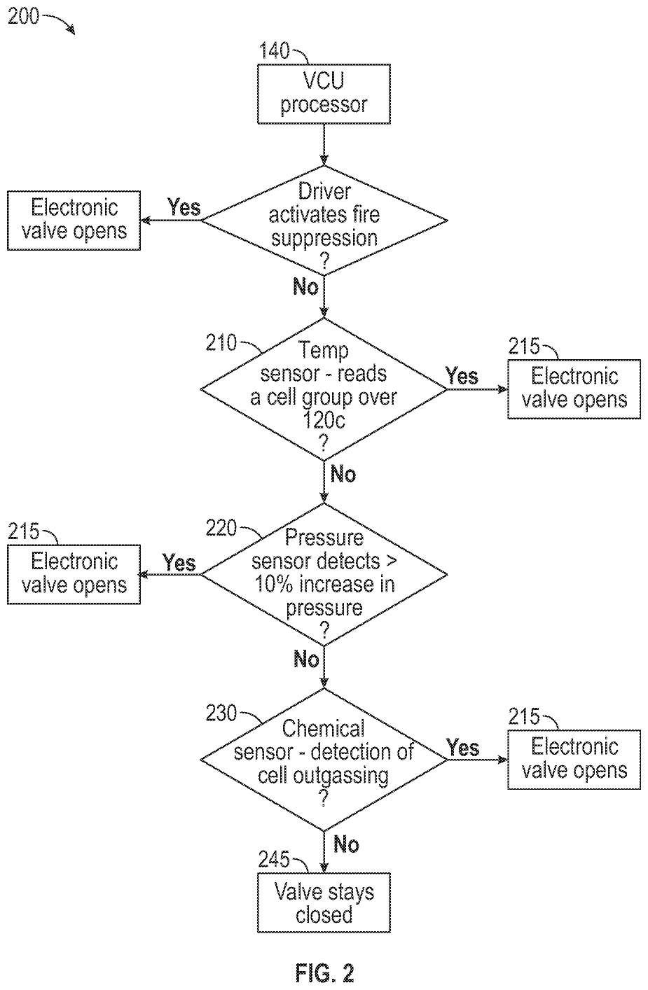

The one or more sensors (e.g., thermistor(s), vibration sensor(s), shock sensor(s), electrical sensor(s), current sensor(s), pressure sensor(s), “sniffers” to detect chemical composition) 110 are internal sensors placed inside the battery pack(s) 130 in order to provide a real time source of data about the state of battery cells to the controller 140 via a wire harness 162. These sensors 110 pass critical data to the controller 140 for real time analysis and processing. In the embodiment(s) shown in FIGS. 1 and 2, the sensor(s) are temperature sensor(s) 164, pressure sensor(s) 166, and chemical sensor(s) 168) installed internally in the battery pack(s) 130.

The controller 140 is a VCU processor or PLC, and gathers the data provided by the sensor(s) 110 and, using a programmed logic, is capable of detecting a potential battery fire. This provides the ability to, then, autonomously deploy the fire suppressant 160 into the battery pack(s) 130 instead of a manual deployment.

The electronically controlled deployment system 150 includes an electronic valve 170 electrically connected to the controller 140 via a wire harness 180 to electronically control the valve 170 for delivering the fire suppressant 160, which is delivered to the electronic valve 170 via a hose 190, to the battery pack(s) 130.

With reference to FIG. 2, an exemplary method of use 200 of the intelligent, autonomous, battery fire suppression system 100 will be described. At 210, the controller 140 determines if the temperature sensor(s) 164 internal to the battery pack(s) 130 read a temperature above a predetermined threshold (e.g., over 120 degrees Celsius). If yes, then the controller 140, at 215, actuates the electronically controlled deployment system 150 to open the electronic valve 170 to deliver the fire suppressant 160. If no, control passes on to 220, where the controller 140 determines if the pressure sensor(s) 166 internal to the battery pack(s) 130 read a pressure above a predetermined threshold. If yes, then the controller 140, at 215, actuates the electronically controlled deployment system 150 to open the electronic valve 170 to deliver the fire suppressant 160. If no, control passes on to 230, where the chemical sensor(s) 168 internal to the battery pack(s) 130 detect for possible cell outgassing. If yes, then the controller 140, at 215, actuates the electronically controlled deployment system 150 to open the electronic valve 170 to deliver the fire suppressant 160. If no, the electronic valve 170, at 245, stays closed and control may pass back to 210.

The intelligent, autonomous, battery fire suppression system 100 is intelligent because it collects real time data from within the battery pack(s) 130, providing early detection, compared to waiting for external signs that the pack is on fire when it is too late. The deployment of the intelligent, autonomous, battery fire suppression system 100 is autonomous based on programmed logic compared to manual deployment which requires a user to become aware of the situation and then deploy a fire suppressant manually.

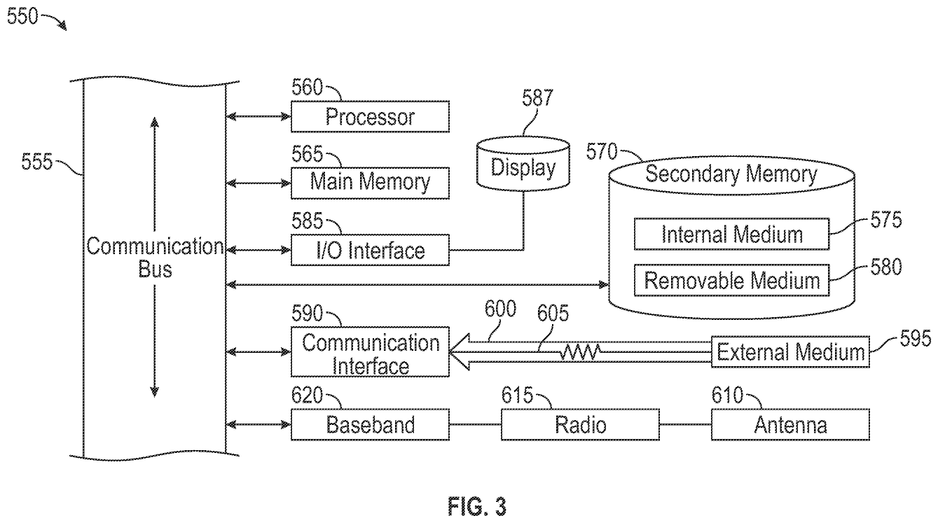

FIG. 3 is a block diagram illustrating an example wired or wireless system 550 that may be used in connection with various embodiments described herein. For example, but not by way of limitation, the system 550 may be used as or in conjunction with the controller 140. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display 587. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network (or otherwise described herein). The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in n terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I/We claim:

1. A battery fire suppression system, comprising:
one or more battery packs;
one or more sensors disposed internal to the one or more battery packs;
a fire suppressant deployment system;
a controller, one or more software modules that, when executed by the controller,
receive one or more signals from the one or more sensors indicative of one or more conditions internal to the one or more battery packs;
actuate the fire suppressant deployment system to deploy a fire suppressant to suppress a fire or possible fire in the one or more battery packs if the one or more signals are indicative of a thermal runaway in the one or more battery packs.

2. The battery fire suppression system of claim 1, wherein the one or more battery packs are one or more lithium-ion battery packs.

3. The battery fire suppression system of claim 1, further including a vehicle including the one or more battery packs.

4. The battery fire suppression system of claim 1, wherein the one or more sensors include one or more of the following sensors: temperature sensor, pressure sensor, chemical sensor, vibration sensor, shock sensor, electrical sensor, current sensor.

5. The battery fire suppression system of claim 1, wherein the one or more sensors include one or more temperature sensors, one or more pressure sensors, and one or more chemical sensors.

6. The battery fire suppression system of claim 1, wherein the fire suppressant deployment system includes an electronic valve, and the one or more software modules that, when executed by the controller, control the electronic valve to deploy a fire suppressant to suppress the fire or possible fire in the one or more battery packs if the one or more signals are indicative of a thermal runaway in the one or more battery packs.

7. The battery fire suppression system of claim 1, wherein the one or more sensors include one or more temperature sensors, and the one or more software modules that, when executed by the controller, actuate the fire suppressant deployment system to deploy a fire suppressant to suppress a fire or possible fire in the one or more battery packs if the one or more signals are indicative of temperature above a threshold in the one or more battery packs.

8. The battery fire suppression system of claim 7, wherein the one or more sensors include one or more pressure sensors, and the one or more software modules that, when executed by the controller, actuate the fire suppressant deployment system to deploy a fire suppressant to suppress a fire or possible fire in the one or more battery packs if the one or more signals are indicative of pressure above a threshold in the one or more battery packs.

9. The battery fire suppression system of claim 7, wherein the one or more sensors include one or more chemical sensors, and the one or more software modules that, when executed by the controller, actuate the fire suppressant deployment system to deploy a fire suppressant to suppress a fire or possible fire in the one or more battery packs if the one or more signals are indicative of cell outgassing in the one or more battery packs.

10. A method of using a battery fire suppression system, comprising:
providing the battery fire suppression system of claim 1;
receiving via the controller the one or more signals from the one or more sensors indicative of one or more conditions internal to the one or more battery packs;
actuating via the controller the fire suppressant deployment system to deploy the fire suppressant to suppress a fire or possible fire in the one or more battery packs if the one or more signals are indicative of a thermal runaway in the one or more battery packs.

11. The method of claim 1, wherein the one or more battery packs are one or more lithium-ion battery packs.

12. The method of claim 10, further including a vehicle including the one or more battery packs.

13. The method of claim 10, wherein the one or more sensors include one or more of the following sensors: temperature sensor, pressure sensor, chemical sensor, vibration sensor, shock sensor, electrical sensor, current sensor.

14. The method of claim 10, wherein the one or more sensors include one or more temperature sensors, one or more pressure sensors, and one or more chemical sensors.

15. The method of claim 10, wherein the fire suppressant deployment system includes an electronic valve, and controller controls the electronic valve to deploy a fire suppressant to suppress the fire or possible fire in the one or more battery packs if the one or more signals are indicative of a thermal runaway in the one or more battery packs.

16. The method of claim 10, wherein the one or more sensors include one or more temperature sensors, and the controller actuates the fire suppressant deployment system to deploy a fire suppressant to suppress a fire or possible fire in the one or more battery packs if the one or more signals are indicative of temperature above a threshold in the one or more battery packs.

17. The method of claim 16, wherein the one or more sensors include one or more pressure sensors, and the controller actuates the fire suppressant deployment system to deploy a fire suppressant to suppress a fire or possible fire in the one or more battery packs if the one or more signals are indicative of pressure above a threshold in the one or more battery packs.

18. The method of claim 17, wherein the one or more sensors include one or more chemical sensors, and the controller actuates the fire suppressant deployment system to deploy a fire suppressant to suppress a fire or possible fire in the one or more battery packs if the one or more signals are indicative of cell outgassing in the one or more battery packs.
